(19) United States
(12) Patent Application Publication
(10) Pub. No.: US 2025/0355452 A1
(43) Pub. Date: Nov. 20, 2025

(54) CURRENT-INTEGRATING SUMMING CIRCUIT

(71) Applicant: Microchip Technology Incorporated, Chandler, AZ (US)

(72) Inventors: Alexander Akbarpour, Mississauga (CA); Jeff Chow, Vancouver (CA)

(73) Assignee: Microchip Technology Incorporated, Chandler, AZ (US)

(21) Appl. No.: 19/213,458

(22) Filed: May 20, 2025

Related U.S. Application Data
(60) Provisional application No. 63/649,670, filed on May 20, 2024.

(51) Int. Cl. G05F 1/56

(52) U.S. Cl. CPC G05F 1/56

(57) ABSTRACT

A current-integrating summing circuit is provided, and may include a first capacitor and a second capacitor to integrate an input current over time, a first pair of transistors to receive a differential pair of input signals, a second pair of transistors to receive a common-mode voltage, a third pair of transistors and a fourth pair of transistors respectively configured in a cascode formation relative to the first pair of transistors and the second pair of transistors, and a pair of complementary clocks to activate the third pair of transistors to enable charging of the first and second capacitors according to the differential pair of input signals during an integration phase, wherein the pair of complementary clocks are to activate the fourth pair of transistors to enable discharging of the first and second capacitors during a reset phase.

### CROSS-REFERENCE TO RELATED APPLICATION(S)

The present application claims priority to U.S. Provisional Patent Application No. 63/649,670, entitled: Current-Integrating Summing Circuit, filed on May 20, 2024, the content of which is hereby incorporated by reference in its entirety.

### TECHNOLOGICAL FIELD

The present disclosure relates generally to summing circuits and, in particular, to current-integrating summing circuits.

### BACKGROUND

Data receivers are responsible for converting received signals into usable data in communication systems, including high-speed wired interfaces like Ethernet and PCIe. Data receivers play a pivotal role in ensuring the accurate and efficient transmission of information over various communication channels. One of the primary challenges faced by data receivers is mitigating the adverse effects of inter-symbol interference (ISI), which occurs when previously transmitted symbols interfere with the current symbol, leading to potential errors in data interpretation.

To address ISI, one effective technique employed in data receivers is the use of decision feedback equalizers (DFEs). DFEs are advanced equalization methods designed to counteract ISI by utilizing past decisions to subtract the estimated ISI from the current received signal. This approach is particularly beneficial in high-speed communication systems where ISI can significantly degrade performance.

An integral component of DFEs, especially in high-speed applications, is the current-integrating (CI) summing circuit (or more simply, “CI summer”). In a DFE, the CI summer is used to equalize incoming data and assist in establishing an error-free link with a far-end data transmitter. The conventional CI summer in a data receiver operates by integrating input data and has two distinct phases: the integration phase and the reset phase. During the integration phase, the input data is integrated, and its value is held for use by downstream blocks until the next reset phase. In the reset phase, the summer is reset to a zero initial condition to prepare for the next integration phase. This reset is used to prevent data-dependent errors in the integration operation.

Ideally, the initial voltage is zero at the start of each integration phase, as described by the relevant equations. During the reset phase, however, the receiver's input data can directly influence the outputs of the summer. This interference prevents the outputs from fully returning to the zero initial condition, leaving a residual voltage behind.

This residual voltage, left over from the reset phase, causes self-generated data-dependent ISI. This reset-phase induced ISI degrades the performance of the summer and the DFE, negatively impacting the receiver's bit-error rate (BER). Additionally, this phenomenon reduces the effective range of the DFE taps, which is undesirable for several reasons. Reset-phase induced ISI is particularly problematic in receiver architectures that do not use track and hold (T/H) circuits, which are designed to avoid signal degradation and related issues.

### BRIEF SUMMARY

Example implementations of the present disclosure are directed to summing circuits and, in particular, to current-integrating summing circuits. The present disclosure includes, without limitation, the following example implementations.

A current-integrating summing circuit including a first capacitor and a second capacitor to integrate an input current over time, a first pair of transistors to receive a differential pair of input signals, a second pair of transistors to receive a common-mode voltage, a third pair of transistors and a fourth pair of transistors respectively configured in a cascode formation relative to the first pair of transistors and the second pair of transistors, and a pair of complementary clocks to activate the third pair of transistors to enable charging of the first and second capacitors according to the differential pair of input signals during an integration phase. The pair of complementary clocks are to activate the fourth pair of transistors to enable discharging of the first and second capacitors during a reset phase.

The complementary clocks are to deactivate the third pair of transistors during the reset phase.

During the reset phase the first and second capacitors are to discharge to the common-mode voltage.

The first pair of transistors and the third pair of transistors form an integration path to enable charging of the first and second capacitors during the integration phase, and the second pair of transistors and the fourth pair of transistors form a reset path to enable discharging of the first and second capacitors during the reset phase.

The current-integrating summing circuit may include first and second current sources to provide respective bias currents to the first and second capacitors, and a comparator to output a drive signal to drive the first and second current sources.

The comparator is to compare a voltage across the first and second capacitors with a reference voltage and output the drive signal based on the comparison.

The current-integrating summing circuit may include first and second resistors coupled between the first and second capacitors to generate a divided voltage based on a voltage across the first and second capacitors. The comparator is to compare the divided voltage with a reference voltage and output the drive signal based on the comparison.

The reference voltage may be the common-mode voltage.

The current-integrating summing circuit may include first and second current mirrors coupled to the first and second pairs of transistors to provide respective bias currents to the first and second capacitors.

According to one or more aspects, there is provided a method including providing a differential pair of input signals to a first pair of transistors, and a common-mode voltage to a second pair of transistors, providing a first clock signal to activate a third pair of transistors coupled in a cascode formation with the first pair of transistors to enable charging of a first capacitor and a second capacitor according to the differential pair of input signals during an integration phase, and providing a second clock signal to activate a fourth pair of transistors coupled in a cascode formation with the second pair of transistors to enable discharging of the first and second capacitors during a reset phase, wherein the second clock signal is complementary to the first clock signal.

The method may include deactivating the third pair of transistors during the reset phase.

During the reset phase the first and second capacitors may discharge to the common-mode voltage.

The method may include providing respective bias currents to the first and second capacitors using first and second current sources, wherein the respective bias currents are controlled by a drive signal.

The method may include comparing a voltage across the first and second capacitors with a reference voltage, and generating the drive signal based on the comparison.

The reference voltage may be the common-mode voltage.

The method may include dividing a voltage across the first and second capacitors to generate a divided voltage, and comparing the divided voltage with a reference voltage, and generating the drive signal based on the comparison.

According to one or more aspects, there is provided a current-integrating summing circuit including a first capacitor and a second capacitor to integrate an input current over time, a first pair of transistors to receive a differential pair of input signals, a second pair of transistors to receive a common-mode voltage, and a third pair of transistors and a fourth pair of transistors respectively coupled to the first pair of transistors and the second pair of transistors. The third pair of transistors are configured to receive a first clock signal to activate the third pair of transistors to enable charging of the first and second capacitors according to the differential pair of input signals during an integration phase. The fourth pair of transistors are configured to receive a second clock signal to activate the fourth pair of transistors to enable discharging of the first and second capacitors during a reset phase, wherein the second clock signal is complementary to the first clock signal.

The first clock is to deactivate the third pair of transistors during the reset phase.

The first pair of transistors and the third pair of transistors form an integration path to enable charging of the first and second capacitors during the integration phase, and the second pair of transistors and the fourth pair of transistors form a reset path to enable discharging of the first and second capacitors during the reset phase.

The current-integrating summing circuit may include a comparator to compare a voltage across the first and second capacitors with a reference voltage and output a drive signal based on the comparison to control a bias current provided to the first and second capacitors.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. The present disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above-described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates a current-integrating summing circuit, according to some example implementations of the present disclosure;

FIG. 2 is an eye diagram of voltage waveforms output by the current-integrating summing circuit of FIG. 1, as compared to a conventional CI summer;

FIG. 3 illustrates decision feedback equalizer (DFE) performance with the conventional CI summer; and

FIG. 4 illustrates DFE performance with the CI summer of example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

Example implementations of the present disclosure relate generally to summing circuits and, in particular, to current-integrating summing circuits (“CI summers”). As explained in the Background section, a CI summer in a data receiver operates by integrating input data and has two distinct phases: the integration phase and the reset phase. During the integration phase, the input data is integrated, and its value is held for use by downstream blocks until the next reset phase. In the reset phase, the summer is reset to a zero initial condition to prepare for the next integration phase. A number of conventional CI summers, however, suffer from residual reset-phase voltage (fuzz) that causes self-generated data-dependent ISI.

The impact of residual reset-phase voltage can be seen in an eye diagram in which samples of the amplitude of a signal are plotted to illustrate variations in the signal over time. A key feature of an eye diagram is the “eye opening,” which is the space between the rising and falling edges of the signal that represents the margin for error in correctly detecting the signal. Residual reset-phase voltage causes increased eye-closure, indicating reduced signal quality and increased error rate. In this regard, the residual reset-phase voltage affects the initial condition of the integrator, meaning that each new bit starts with a non-zero initial voltage. This disrupts the precise integration needed for accurate signal processing, leading to timing and amplitude errors that cause the eye diagram to close.

Residual reset-phase voltage can also degrade performance of a DFE. As explained above, the DFE is used to mitigate ISI, which is interference from previous bits affecting the current bit. Residual reset-phase voltage acts like an additional source of ISI, exacerbating the problem instead of reducing it. The DFE now has to deal with both the intended signal and the unintended residual effects, leading to degraded performance.

In view of the foregoing, example implementations of the present disclosure provide a CI summer in a circuit topology that may nullify the residual reset-phase voltage otherwise present in a conventional CI summer. Relative to the conventional CI summer, the CI summer of example implementations may improve self-generated ISI and DFE performance, which directly contributes to an improvement in the performance of a receiver that includes the CI summer.

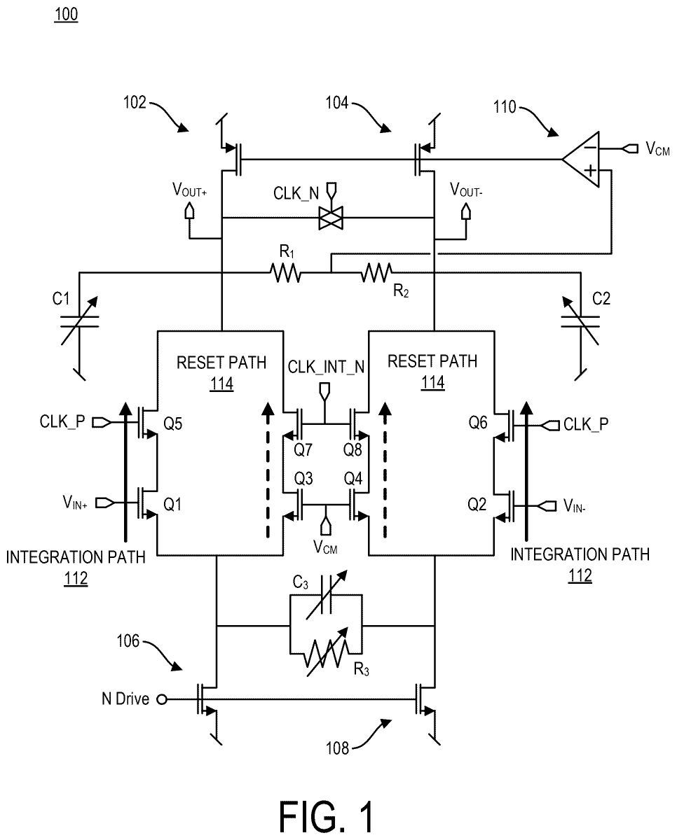

FIG. 1 illustrates a CI summer 100 according to some example implementations of the present disclosure. The CI summer is at times referred to as a drain track and reset (DTR) summer. The CI summer includes capacitors C₁, C₂ that integrate input current flowing through the capacitors over time, effectively accumulating charge. The CI summer includes active current sources 102, 104 and current mirrors 106, 108 to provide controlled bias currents to the capacitors. As shown, in some examples, the active current sources 102, 104 and current mirrors 106, 108 may be implemented by respective transistors.

The active current sources 102, 104 are connected to the positive rail and driven by a comparator 110, and the current mirrors 106, 108 are connected to the negative rail and driven by an N drive signal. The comparator 110 regulates the active current sources 102, 104, and compares the voltage across the capacitors (proportional to the integrated current) with a reference, common-mode voltage V_{CM} (e.g., 0 volts). The CI summer 100 may include resistors R₁, R₂ to reduce the voltage across the capacitors for comparison with the common-mode voltage.

The CI summer 100 may include a first pair of transistors Q₁, Q₂ to receive a differential pair of input signals V_{IN+}, V_{IN-}, and a second pair of transistors Q₃, Q₄ to receive the common-mode voltage V_{CM}. As described below, the second pair of transistors Q₃, Q₄ operate as a replicate of the first pair of transistors Q₁, Q₂, but for the common-mode voltage V_{CM}.

The CI summer 100 may also include a third pair of transistors Q₅, Q₆ and a fourth pair of transistors Q₇, Q₈ that are configured in a cascode-like formation. These two pairs of transistors Q₅, Q₆ and Q₇, Q₈ are closed in such a way to allow for the activation and deactivation of the first pair of transistors Q₁, Q₂ and the second pair of transistors Q₃, Q₄ in a non-overlapping fashion.

The CI summer 100 is operable in an integration phase and a reset phase, each of which has an associated current path. In particular, the integration phase has an associated integration path 112, and the reset phase has an associated reset path 114. During the integration phase, complementary clocks (CLK_P, CLK_N) activate the integration path 112 by enabling the third pair of transistors Q₅, Q₆. The first pair of transistors Q₁, Q₂ are activated according to the differential pair of input signals V_{IN+}, V_{IN-}. Charge also accumulates in capacitors C₁, C₂ according to V_{IN+}, V_{IN-}, and voltage across the capacitors is indicated at outputs V_{OUT+}, V_{OUT-}.

During the reset phase, the complementary clocks (CLK_P, CLK_N) activate the reset path 114 by enabling the fourth pair of transistors Q₇, Q₈. The second pair of transistors Q₃, Q₄ are activated according to the common-mode voltage V_{CM}, allowing the capacitors C₁, C₂ to discharge to V_{CM}. Simultaneously with the complementary clocks (CLK_P, CLK_N) enabling the fourth pair of transistors Q₇, Q₈, the complementary clocks deactivate third pair of transistors Q₅, Q₆ so that the differential pair of input signals V_{IN+}, V_{IN-} no longer influence the outputs V_{OUT+}, V_{OUT-}. When the CI summer 100 transitions to the next integration phase (on the next clock pulse of the complementary clocks), the charge in the capacitors C₁, C₂ is therefore closer to V_{CM} (e.g., 0 volts), without influence from V_{IN+}, V_{IN-}.

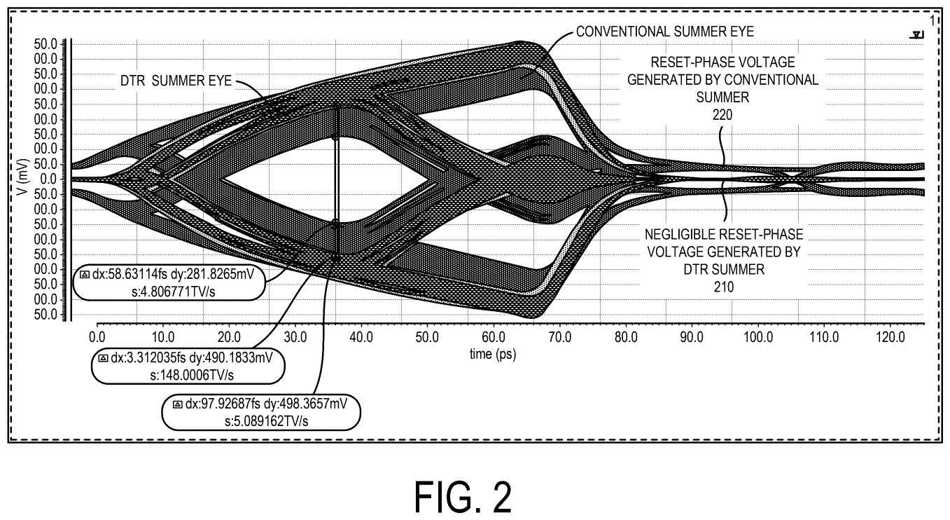

FIG. 2 is an eye diagram of voltage waveforms output by the CI summer 100 of FIG. 1 (identified in the figure as “DTR summer”), as compared to a conventional CI summer. As shown, the CI summer of example implementations suppresses the residual reset-phase voltage 210 (fuzz). This is in contrast with the larger reset-phase voltage 220 generated by the conventional CI summer. It is evident that the eye-opening of the CI summer of example implementations is improved relative to the conventional summer. As shown, the curve generated by the conventional CI summer fits inside the curve generated by the CI summer of example implementations. In the illustrated example, the eye opening of the conventional CI summer is approximately 282 millivolts, while the eye opening of the CI summer of example implementations is approximately 490 millivolts.

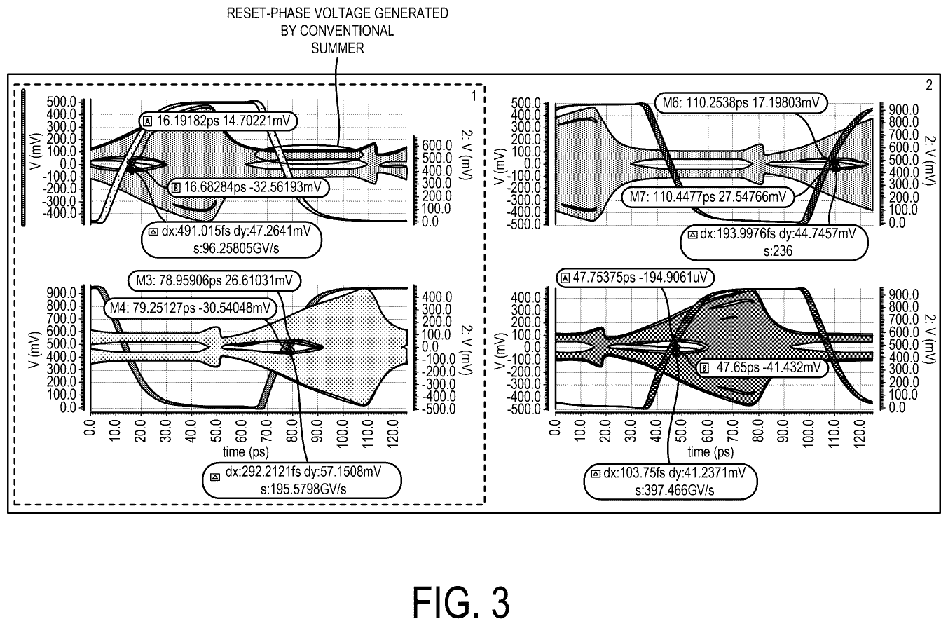

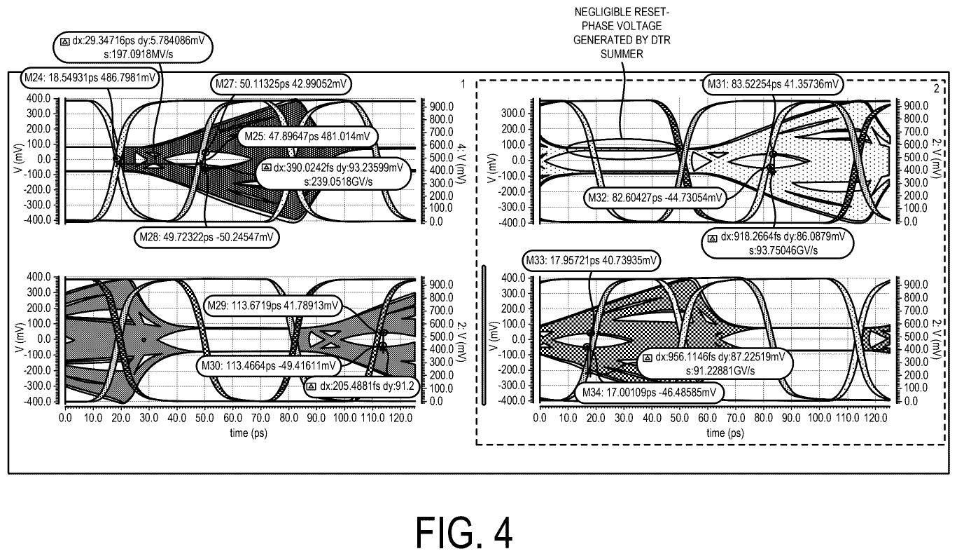

FIG. 3 illustrates DFE performance with the conventional CI summer, and FIG. 4 illustrates DFE performance with the CI summer of example implementations. As shown in FIG. 3, the large residual reset-phase voltage is clearly visible in all four phases of the DFE (phase 0 is circled in the figure). As shown, the eye height is heavily degraded and is measured to be approximately 41 millivolts (worst-case eye height). This degraded performance hinders the ability of a receiver to recover the received data in an error-free manner. By comparison, as highlighted in FIG. 4, the residual reset-phase voltage is greatly suppressed by the CI summer of example implementations, and is now negligible. The eye performance is improved by a factor of two and the eye height is approximately 86 millivolts (worst-case eye-height). Overall, the CI summer of example implementations is exhibiting a superior eye performance and better signal integrity.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A current-integrating summing circuit comprising:
a first capacitor and a second capacitor to integrate an input current over time;
a first pair of transistors to receive a differential pair of input signals;
a second pair of transistors to receive a common-mode voltage;
a third pair of transistors and a fourth pair of transistors respectively configured in a cascode formation relative to the first pair of transistors and the second pair of transistors; and
a pair of complementary clocks to activate the third pair of transistors to enable charging of the first and second capacitors according to the differential pair of input signals during an integration phase;
wherein the pair of complementary clocks are to activate the fourth pair of transistors to enable discharging of the first and second capacitors during a reset phase.

2. The current-integrating summing circuit of claim 1, wherein the complementary clocks are to deactivate the third pair of transistors during the reset phase.

3. The current-integrating summing circuit of claim 1, wherein during the reset phase the first and second capacitors are to discharge to the common-mode voltage.

4. The current-integrating summing circuit of claim 1, wherein the first pair of transistors and the third pair of transistors form an integration path to enable charging of the first and second capacitors during the integration phase, and the second pair of transistors and the fourth pair of transistors form a reset path to enable discharging of the first and second capacitors during the reset phase.

5. The current-integrating summing circuit of claim 1 comprising:
first and second current sources to provide respective bias currents to the first and second capacitors; and
a comparator to output a drive signal to drive the first and second current sources.

6. The current-integrating summing circuit of claim 5, wherein the comparator is to compare a voltage across the first and second capacitors with a reference voltage and output the drive signal based on the comparison.

7. The current-integrating summing circuit of claim 5 comprising:
first and second resistors coupled between the first and second capacitors to generate a divided voltage based on a voltage across the first and second capacitors;
wherein the comparator is to compare the divided voltage with a reference voltage and output the drive signal based on the comparison.

8. The current-integrating summing circuit of claim 5, wherein the reference voltage is the common-mode voltage.

9. The current-integrating summing circuit of claim 5 comprising:
first and second current mirrors coupled to the first and second pairs of transistors to provide respective bias currents to the first and second capacitors.

10. A method comprising:
providing a differential pair of input signals to a first pair of transistors, and a common-mode voltage to a second pair of transistors;
providing a first clock signal to activate a third pair of transistors coupled in a cascode formation with the first pair of transistors to enable charging of a first capacitor and a second capacitor according to the differential pair of input signals during an integration phase;
providing a second clock signal to activate a fourth pair of transistors coupled in a cascode formation with the second pair of transistors to enable discharging of the first and second capacitors during a reset phase, wherein the second clock signal is complementary to the first clock signal.

11. The method of claim 10, comprising deactivating the third pair of transistors during the reset phase.

12. The method of claim 10, wherein during the reset phase the first and second capacitors discharge to the common-mode voltage.

13. The method of claim 10, comprising:
providing respective bias currents to the first and second capacitors using first and second current sources, wherein the respective bias currents are controlled by a drive signal.

14. The method of claim 13, comprising:
comparing a voltage across the first and second capacitors with a reference voltage; and
generating the drive signal based on the comparison.

15. The method of claim 14, wherein the reference voltage is the common-mode voltage.

16. The method of claim 13, comprising:
dividing a voltage across the first and second capacitors to generate a divided voltage; and
comparing the divided voltage with a reference voltage, and generating the drive signal based on the comparison.

17. A current-integrating summing circuit comprising:
a first capacitor and a second capacitor to integrate an input current over time;
a first pair of transistors to receive a differential pair of input signals;
a second pair of transistors to receive a common-mode voltage; and
a third pair of transistors and a fourth pair of transistors respectively coupled to the first pair of transistors and the second pair of transistors;
wherein the third pair of transistors are configured to receive a first clock signal to activate the third pair of transistors to enable charging of the first and second capacitors according to the differential pair of input signals during an integration phase; and
wherein the fourth pair of transistors are configured to receive a second clock signal to activate the fourth pair of transistors to enable discharging of the first and second capacitors during a reset phase, wherein the second clock signal is complementary to the first clock signal.

18. The current-integrating summing circuit of claim 17, wherein the first clock is to deactivate the third pair of transistors during the reset phase.

19. The current-integrating summing circuit of claim 17, wherein the first pair of transistors and the third pair of transistors form an integration path to enable charging of the first and second capacitors during the integration phase, and the second pair of transistors and the fourth pair of transistors form a reset path to enable discharging of the first and second capacitors during the reset phase.

20. The current-integrating summing circuit of claim 17, comprising:
a comparator to compare a voltage across the first and second capacitors with a reference voltage and output a drive signal based on the comparison to control a bias current provided to the first and second capacitors.
